(19) United States
(12) Patent Application Publication
(10) Pub. No.: US 2013/0297251 A1
(43) Pub. Date: Nov. 7, 2013

(54) System and Method For Determining High Resolution Positional Data From Limited Number of Analog Inputs

(71) Applicant: ABL IP HOLDING, LLC, Conyers, GA (US)

(72) Inventors: Aaron Mathew Engel-Hall, San Francisco, CA (US); Min-Hao Michael Lu, Castro Valley, CA (US)

(21) Appl. No.: 13/888,046

(22) Filed: May 6, 2013

Related U.S. Application Data
(60) Provisional application No. 61/643,183, filed on May 4, 2012.

(51) Int. Cl. G01B 21/16; G06F 3/01

(52) U.S. Cl. CPC G01B 21/16; G06F 3/011
USPC 702/150

(57) ABSTRACT

A system and method for determining the position of an object in a space includes positioning the object within the overlapping detection fields of a plurality of analog proximity sensors, wherein the proximity sensors produce an output signal having a signal strength related to the proximity of the object to the sensors. The strength of the output signal produced by each analog proximity sensor can be detected and a position for the object established based on the relative signal strengths produced by the proximity sensors. The system and method have particular application with devices for gestural control, for example gestural controlled dimmer switches, where some data manipulation is required to generate high-resolution positional data to activate the device.

### CROSS-REFERENCE TO RELATED APPLICATIONS

This application claims the benefit of U.S. Provisional Patent Application No. 61/643,183 filed May 4, 2012, which is incorporated herein by reference.

### FIELD OF THE INVENTION

The present invention generally relates to extracting data from sensor inputs, and particularly to extracting useable data in a system environment where very few sensor inputs are available. The invention has particular application with devices for gestural control where some data manipulation is required to generate high-resolution and precise positional data such as might be used to activate a gestural controlled light dimmer switch.

### BACKGROUND

Many applications for position sensing devices, especially in gesture recognition, need high-resolution positional data in order for a device to react appropriately to a user's commands. Using digital sensors (a sensor with only two states), high resolution can only be achieved by a large number of sensors. In the case of a touchless panel for a gestural controlled dimmer switch, high resolution vertical positional data would require a high density of digital sensors arranged vertically or perhaps in an arc within an occlusion. This translates into higher device costs, more necessary inputs to microprocessors, and/or the necessity of multiplexers. These problems are compounded (to the 2^{nd} power) when 2D positional data is required and further compounded (to the 3^{rd} power) for 3D data.

The present invention provides a system and method of obtaining high-resolution positional data from just a few sensors, thereby lowering the complexity and costs associated with the system design. The invention has particular application for gestural control switches, such as dimmer switches, where high resolution positional data is require to properly activate the switch.

### BRIEF DESCRIPTION OF THE DRAWINGS

FIG. 1 is a graphical view of a gestural control dimmer switch showing a hand positioned in front of a plurality of analog proximity sensors.

FIG. 2 is another graphical view thereof showing the hand in a different position over the proximity sensors.

FIG. 3 a graphical side elevational view of the dimmer switch panel such as shown in FIGS. 1 and 2, showing the overlapping detection fields of the proximity sensors.

FIG. 4 is a diagram showing the relative signal strengths of the signal output produced by the analog proximity sensors in response to an object in a first position within the overlapping detection fields of the sensors.

FIG. 5 is a diagram showing the relative signal strengths of the signal outputs produced by the analog proximity sensors in response to an object in a second position within the overlapping detection fields of the sensors.

FIG. 6 is graphical representation of a gestural controlled dimmer switch with eight analog proximity sensors and a processor for generating high-resolution positional data in accordance with the invention from analog outputs produced by the sensors in response to an object such as a hand positioned in the overlapping detection fields of the sensors.

FIG. 7 is a flow chart illustrating a method for generating high-resolution positional data for activating an adjustment control of a device such as a gestural controlled dimmer switch in response to an object such as a hand positioned in the overlapping detection fields of a plurality of analog proximity sensors.

### DETAILED DESCRIPTION

As used herein, “analog” sensors mean sensors capable of outputting a variable analog voltage (or other multi-state signal) to be read by a processor. In the example of touchless panels for gestural controlled dimmer switches, these devices can be photodiodes, which might be loosely regarded as “digital” in that they are solid state devices, but which are not limited to simple HI or LO output values. The reference to “analog” sensors takes into account such devices, that is, devices with more than two states.

The present invention eliminates the need for large arrays of digital sensors, using instead far fewer analog sensors. This results in far fewer parts, potentially cheaper and smaller devices, as well as less obtrusive sensing (if the sensors cannot be hidden). For instance, a touchless panel for gestural control is easily capable of generating data points at a resolution of approximately 1K bits using a few, for example eight, analog sensors instead of the relatively large number of digital sensors (typically in the range of a thousand sensors) that would otherwise be required.

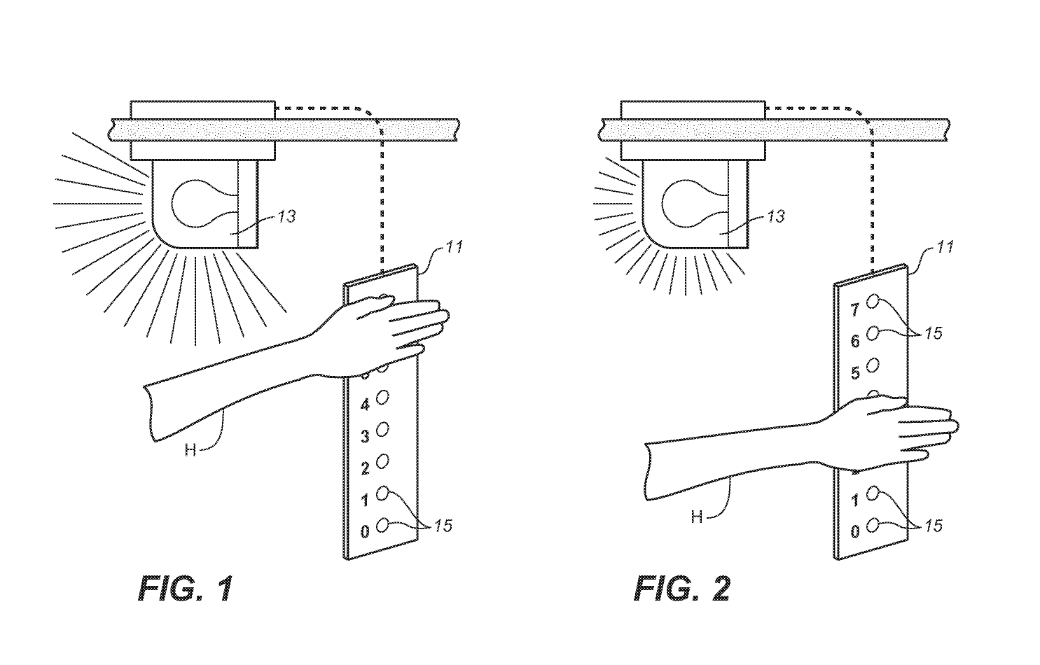

Referring now to the drawings, FIGS. 1 and 2 illustrate an exemplary touchless panel 11 for gestural control of a light 13. Panel 11 is comprised of eight proximity sensors, generally denoted by the numeral 15 stacked vertically at positions denoted 0, 1, 2, 3, 4, 5, 6 and 7. The sensors 15 are shown as being evenly spaced one above the other, however, the sensors could be unevenly spaced. Indeed, it is not necessary that the sensors be aligned or in a plane. The only requirement is that the relative positioning of the sensors be known and quantified and that the sensors be positioned close enough to each other that their detection fields overlap as hereinafter described. The proximity sensor can be active sensors such as an IR emitter and detector pair or passive sensors that detect changes in ambient conditions within the detection field of the sensors, such as IR detectors (photodiodes) alone or capacitive sensors. In the case of an active IR emitter/detector pair, the IR emitters would be tuned to the most responsive wavelength of the photodiodes.

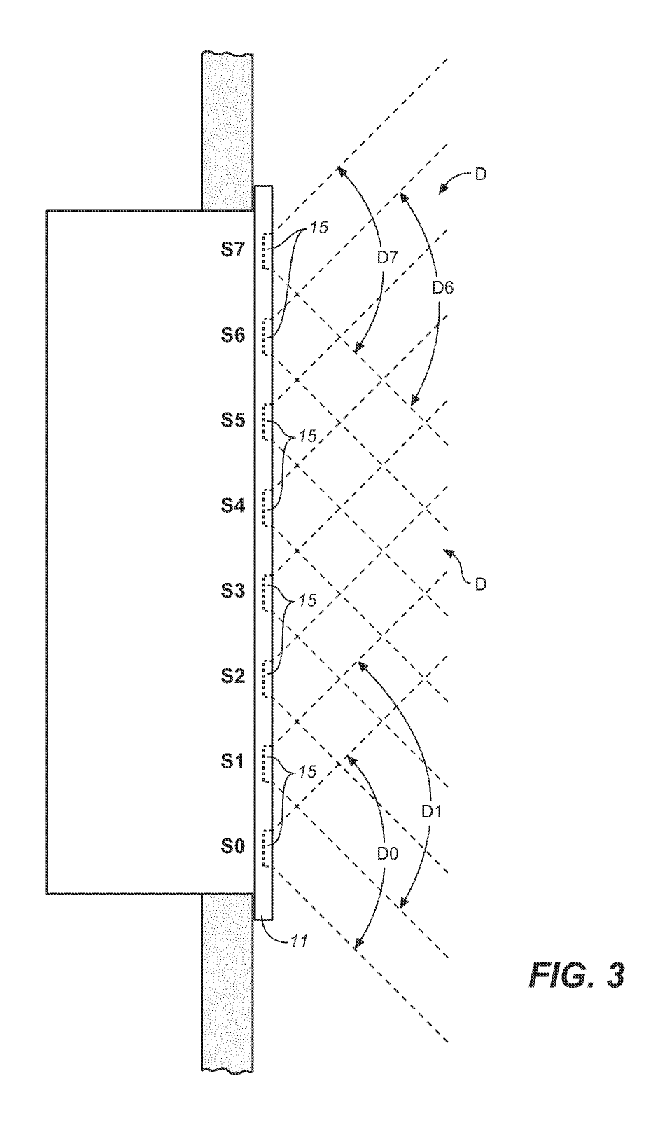

As illustrated in FIG. 3, each vertically aligned sensor 15 of the touchless panel 11 has a detection field, represented by the dashed lines “D.” The detection fields are generally the volume of space in front of the sensor where an object positioned in the space will be detected by the sensor and where the sensor will generate an output signal in response to the presence of the object. It can be seen in FIG. 3 that the detection fields D of sensors 15 overlap. For example, the detection field D0 of sensor S0 is seen to overlap with detection field D1 of sensor S1 and also with upstream sensors. Similarly, the detection field D7 of sensor S7 is seen to overlap with the detection field D6 of sensor S6 and with other downstream sensors. It will be appreciated that the dashed lines D in FIG. 3 representing the detections fields are for illustrative purposes only and that the detection fields for particular sensors can be wider or narrower than shown.

The positioning of an object in the detection field of sensors 15 can, for example, be a matter of positioning a hand in front of the touchless panel, such as the hand “H” shown in FIGS. 1 and 2 in front of the touchless dimmer switch panel 11. In FIG. 1 the hand is positioned near the top of the touchless panel more or less in front of sensors S5 and S6; in FIG. 2 the hand is positioned near the bottom of the panel more or less in front of sensor's S3 and S4. The presence of the hand in front of these different sensors will cause the sensors and adjacent sensors where the hand is in the detection field of the sensors to produce sensor outputs, typically a voltage (e.g. 1 to 5 volts), that is proportional to the amount of the hand in a sensor's detection field and the distance of the hand surfaces from the sensor.

For example where photo-detection is used (a photodiode) a sensor output will be proportional to the intensity of light reflected off the hand placed in the field of detection for the photodiode. With the vertically arranged sensors shown in FIGS. 1 and 2, a hand positioned at the very bottom of the touchless panel 11 will cause the bottom most sensor, S0, to see the most reflected light, the sensor, S1, which is above the bottom-most sensor to see somewhat less reflected light, and the sensor above that to see still less reflected light, until near the top the panel reflected light is too weak to be registered by the top-most sensors (e.g. sensors S3-S7). As the hand moves upward to the point between the two lowest sensors, those two lowest sensors, S0 and S1 will see about the same amount of light, and the third sensor S3 will see slightly less than either bottom two, while the fourth sensor S4 will see even less than the bottom three sensors, etc.

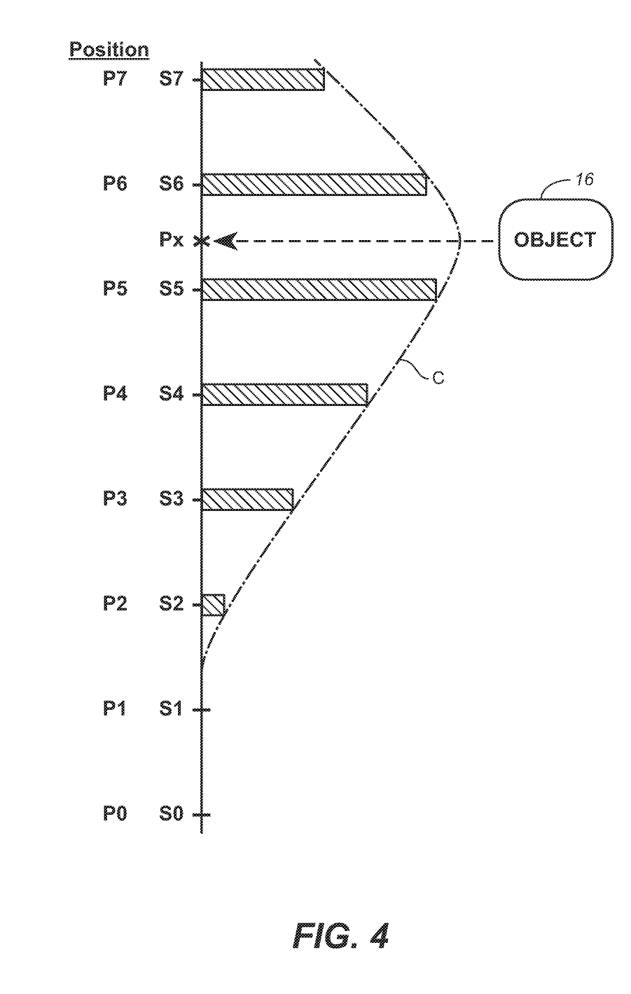

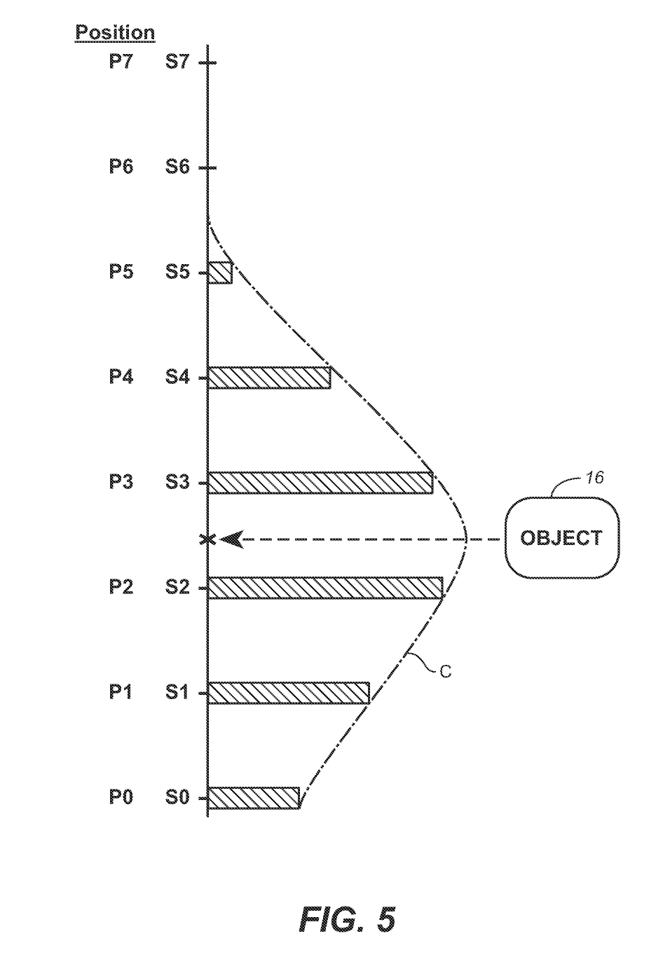

FIGS. 4 and 5 graphically illustrate this phenomenon and the relative strengths of the output signals produced by eight vertically arranged proximity sensors, S0 through S7 located and positions P1 through P7. This arrangement of proximity sensors is the same as the vertical arrangement of sensors on the touchless panel 11 shown in FIGS. 1 and 2. In FIGS. 4 and 5, the object, denoted by the numeral 16, can be a hand as shown in FIGS. 1 and 2 or any other object (including another body part) of suitable size that is positionable in the detection fields of the sensors. FIG. 4 shows the object positioned between sensors S5 and S6, which roughly corresponds to the hand position in front of the touchless panel seen in FIG. 1. Sensors S5 and S6, being closest to the object, produce the highest signal outputs as represented by the S5 and S6 signal strength bars on the FIG. 4 graph. The signal strengths for S4 and S7 on either side of S5 and S6 are seen to fall off as represented by the signal strength bars of S5 and S7. The signal strengths for S3 and S2 continue to fall off, while the signal strengths for 51 and SO are essentially zero because the object is substantially out of the detection field of these sensors. The above-described distribution of signal strengths assume the use of analog proximity sensors that have detection fields wide enough to produce the indicated responses.

The distribution of signal strengths for the signal outputs for all the sensors shown in FIG. 4 roughly corresponds to a normal distribution and can be represented by a signal-strength curve such as the curve denoted C in FIG. 4. The center of the object will approximately correspond to the median of this signal-strength curve. In the idealized curve, the median is exactly equal to the center of the hand; however in reality one would not see a perfect curve but instead eight noisy data points from which the discrete equivalent of the median can be extracted.

FIG. 5 shows the object 16 moved down between sensors S2 and S3, which roughly corresponds to the hand position in front of the touchless panel seen in FIG. 2. Sensors S2 and S3, being closest to the object, produce the highest signal outputs as represented by the S2 and S3 signal strength bars on the FIG. 5 graph. The signal strengths for 51 and S4 on either side of S2 and S3 are seen to fall off as represented by the signal strength bars of S1 and S4. The signal strengths for SO and S5 continue to fall off, while the signal strengths for S6 and S7 are essentially zero. Curve C is the signal-strength curve for the distribution of signal strengths for this object position. It can be seen that the signal-strength curve in FIG. 5 is essentially the same as the curve in FIG. 5, except that the curve is slid down toward the bottom of the sensor array.

It should be noted that the object 16 can be positioned above or below the end-most sensors S0 or S7 and still be detected so long as the object is still within the detection fields of either of these sensors. For example, an object just above sensor S7 will produce signal outputs of diminishing signal strengths from the top-most sensors beginning with sensor S7.

Determining the Position of the Detected Object: Using the relative signal strengths produced by multiple proximity sensors, such the generated signal strengths for sensors S0-S7 illustrated in FIGS. 4 and 5, an approximate object position, denoted px, can be determined. The determination will produce a useable signal output or data point(s) representative of the position of the object in the overlapping detection fields of the proximity sensors.

Depending on the method used to determine the object position, px, the determined position will be a point in space on or within the object that locates the object. Preferably, this point in space will be roughly centered on or within the physical mass of the object. The roughly centered point is herein referred to as the “centroid” of the object. The centroid of the object would then be the objects position, px.

To determine the centroid of an object such as the centroid of a hand placed in the overlapping detection fields of a plurality of proximity sensors as above described, data from the proximity sensors outputs, such as the signal strength values illustrated in FIGS. 4 and 5, can be used to calculate px using an extrapolation technique called the “Center of Mass Method.” This technique involves a process of determining the center or centroid of the object and can be employed to determine a usable centroid value, px, for a hand or other irregular object, even though the calculated centroid position value may not represent the center of mass of the hand. All that is required is that a usable “centroid” position be determined that is between the extremities of the hand.

Using the center of mass method, each sensor, such as sensors S0-S7 in FIGS. 4 and 5, is assigned a position. The absolute positions of the sensors need not be known, only their relative positions. The signal strength values for each proximity sensor produced as above-described in response to the presence and proximity of the object to the sensor provide data points that are analogous to the mass of the object. Using this analogy the equation for determining the “center of mass” of the object is as follows:

$$CM = \frac{1}{Σ s} Σ s \cdot p$$

where s is the signal strength and p is the position of each sensor respectively. More appropriately, it can be said that this equation determines the center of the signal strength (“COSS”). It results in a determination of the approximate center or centroid of the object, that is, a value for px.

In the above equation, both sums are carried out over all sensors and the resulting COSS is equal to the relative position of the center of the object positioned in the detection fields of the sensors, or as illustrated the center of the hand H shown in FIGS. 1 and 2. This calculation technique requires very little processing power as very few data points need be summed. Also, unlike approaches that use a large array of digital sensors, the COSS calculation technique is not thrown off by irregular shapes. Furthermore this technique allows the introduction of curve fitting techniques if desired, which require more processing power but also provide a greater wealth of gestural information.

The COSS calculation technique is also relatively robust. As above-described, the resulting signal strengths from analog sensors detecting a hand (or other object) will roughly be a normal distribution centered on the hand. This allows a richer amount of data to be reliably calculated if desired. By calculating the standard deviation of these few data points (which is still minimally processor intensive), the relative orientation of the hand can be determined. Larger standard deviations would correspond to a palm parallel to the device while smaller standard deviations would correspond to a palm parallel to the floor. Furthermore larger or smaller peak values of the normal distribution would correspond to a hand closer or further from the device in the horizontal direction. A form of triangulation could be possible in connection with the above-described methodology and an extrapolation of a normal distribution can be produced for locating an object above or below the end most sensors where the variation in signal strengths produced by the sensors do not produce a normal distribution with a peak.

As above-mentioned, the foregoing can be achieved with very few analog proximity sensors. It is contemplated that the number of analog sensors can be as few as five and possibly less depending on the sensor type.

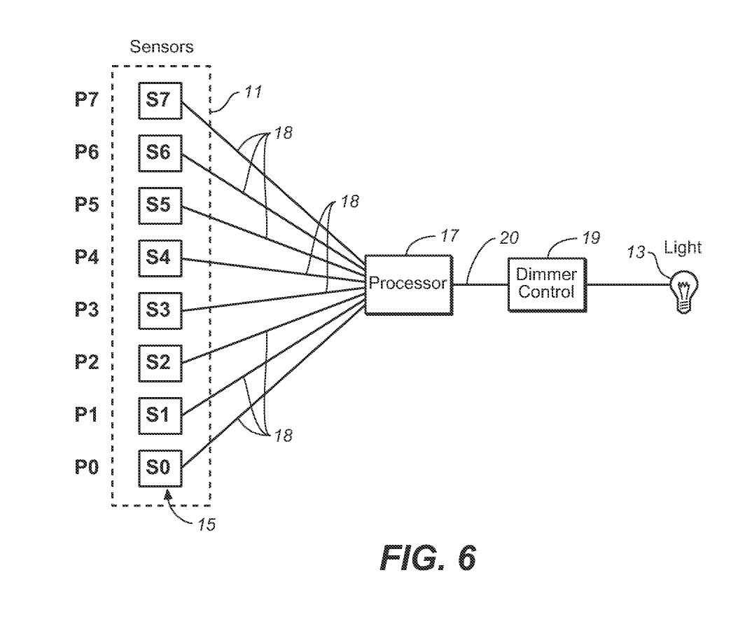

FIG. 6 illustrates the components of a system for determining high resolution positional data from limited number of inputs in accordance with the invention as used in a gestural controlled dimmer switch. The system is comprised of a touchless panel 11 having eight proximity sensors 15 (separately denoted sensors S0, S1, S2 . . . S7) located at determinable positions p0, p1, p2 . . . p7. Proximity sensors 15 have overlapping detection fields as above-described and produce signal outputs at outputs 18 in response to the positioning of an object, such as a hand, within their detection fields. As also above-described, the strength of the signal output of each sensor 15 will be related to the proximity of the object to the sensor. The outputs 18 of the sensors are fed to a processor 17 that uses the signal strength inputs from the sensors 15 to calculate the position, px, of the centroid of the object, such as by using the above-described COSS calculation method. The processor uses the positional data derived from this calculation to generate a signal output 20 for activating a dimmer switch control 19, which in turn adjusts the intensity of the light 13.

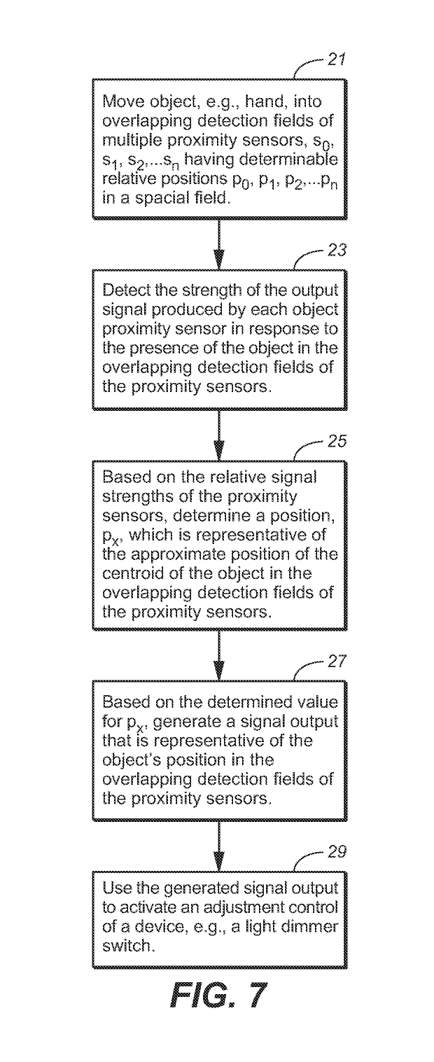

The overall method of the invention can further be described in reference to the flow chart in FIG. 7, wherein the first step of the method as represented by block 21 includes moving an object, e.g., the hand shown in FIGS. 1 and 2, into the overlapping detection fields of analog proximity sensors, s0, s1, s2, . . . sn having determinable relative positions p₀, p₁, p₂, . . . pn in a spacial field. The next step, as represented by block 23, is to detect the strength of the output signal produced by each proximity sensor in response to the presence of the object in the overlapping detection fields of the proximity sensors. Then, as represented by block 25, a position, px, is determined based on the relative signal strengths of the proximity sensors. This determination is preferably made by the above-described COSS calculation method and will produce a position data representative of the approximate position of the object's centroid in the overlapping detection fields of the proximity sensors.

Once a value is obtained for px, the next step is to generate a signal output based on the determined value for px that is representative of the object's position in the sensor's overlapping detection fields (box 27). This signal output can then be used to activate an adjustment control of a device, e.g., a light dimmer switch (box 29).

While implementation of the system and method of the invention have been described in considerable detail in the forgoing specification and the accompanying drawings, it is not intended that the invention be limited to such detail, except as necessitated by the following claims.

What I claim is:

1. A method for determining the position of an object in a space from a plurality of proximity sensors having overlapping detection fields and known relative positions within the space comprising:
positioning the object within the overlapping detection fields of the proximity sensors, wherein the proximity sensors are analog sensors that produce an output signal having a signal strength related to the proximity of the object to the sensors,
detecting the strength of the output signal produced by each object proximity sensor in response to the presence of the object in the overlapping detection fields of the proximity sensors,
determining a position, px, for the object based on the relative signal strengths of the proximity sensors, and
generating a signal output that is representative of the object's position in the overlapping detection fields of the proximity sensors.

2. The method of claim 1 further comprising the step of using the generated signal output that is representative of the object's position to activate an adjustment control of a device.

3. The method of claim 2 wherein the generated signal output that is representative of the object's position is used to activate a dimmer switch.

4. The method of claim 1 wherein the step of determining a position, px, for the object based on the relative signal strengths of the proximity sensors includes determining the approximate location of the centroid of the object.

5. The method of claim 1 wherein the step of determining a position, px, for the object based on the relative signal strengths of the proximity sensors includes determining the center of signal strength (COSS) of the detected strengths of the output signals produced by object proximity sensors.

6. The method of claim 5 wherein the COSS is determined in accordance with the following formula:
$$COSS = \frac{1}{Σ s} Σ s \cdot p$$
where s is the signal strength and p is the position of each sensor.

7. The method of claim 1 wherein the multiple proximity sensors are arranged in a plane.

8. The method of claim 1 wherein the multiple proximity sensors are aligned in a plane.

9. The method of claim 8 wherein the spacing between adjacent proximity sensors are substantially the same for all proximity sensors.

10. A method for determining the position of an object in a space from multiple proximity sensors having overlapping detection fields and known relative positions within the space comprising:
positioning the object within the overlapping detection fields of the proximity sensors, wherein the proximity sensors are analog sensors and produce an output signal having a signal strength related to the proximity of the object to the proximity sensors, and wherein there is a center of the signal strengths for the output signals of the sensors,
detecting the strength of the output signal produced by each object proximity sensor in response to the presence of the object in the overlapping detection fields of the proximity sensors,
determining a position, px, for the centroid of object based on the relative signal strengths of the proximity sensors, wherein the centroid of the object is determined from the center of the signal strength (COSS) of the output signals of the sensors in accordance with the following formula:
$$COSS = \frac{1}{Σ s} Σ s \cdot p$$
where s is the signal strength and p is the position of each sensor,
generating a signal output that is representative of the object's determined centroid position,
using the generated signal output representing the object's centroid position to activate an adjustment control of a device.

11. The method of claim 10 wherein the number of proximity sensors is relatively small.

12. A system for determining the position of an object in a space comprising:
a plurality of analog proximity sensors arranged at known relative positions within the space and having overlapping detection fields, each of said analog proximity sensors including an output and being adapted to produce an output signal at said output having a signal strength related to the proximity of an object to the proximity sensors,
a processor for receiving the outputs of said analog proximity sensors and determining a position, px, for the object based on the relative signal strengths of the proximity sensors, said processor generating a signal output that is representative of the object's position, px, in the overlapping detection fields of the proximity sensors.

13. The system of claim 12 wherein the determined position, px, for the object is the approximate position of the centroid of the object.

14. The system of claim 12 wherein the determined position, px, for the object is based on determining the center of signal strength (COSS) of the detected strengths of the output signals produced by object proximity sensors.

15. The system of claim 14 wherein COSS is determined in accordance with the following formula:
$$COSS = \frac{1}{Σ s} Σ s \cdot p$$
where s is the signal strength and p is the position of each sensor.

16. The system of claim 12 wherein the plurality of proximity sensors are arranged in a plane.

17. The system of claim 12 further comprising a touchless panel and wherein said plurality of proximity sensors are aligned on said touchless panel.

18. A gestural control dimmer switch comprising:
a touchless panel,
a plurality of analog proximity sensors arranged on said touchless panel at positions p0, p1, p2, . . . , pn, where n+1 is the number of analog proximity sensors, said proximity sensors having overlapping detection fields,
each of said proximity sensors including an output and being adapted to produce an output signal at said output having a signal strength related to the proximity of an object to the proximity sensors, and
a processor for receiving the outputs of said analog proximity sensors and determining an approximate position, px, for the centroid of the object based on the relative signal strengths of the proximity sensors, said processor generating a signal output that is representative of the object's approximate centroid position, px, in the overlapping detection fields of the proximity sensors, said processor generating a signal output that is representative of the object's approximate centroid position for adjusting the illumination level of one or more lights.

19. The dimmer switch of claim 18 wherein px can be between p0 and pn or above pn or below p0.

20. The dimmer switch of claim 18 wherein the determined approximate position, px, of the centroid of the object is based on determining the center of signal strength (COSS) of the detected strengths of the output signals produced by object proximity sensors.

21. The dimmer switch of claim 20 wherein COSS is determined in accordance with the following formula:
$$COSS = \frac{1}{Σ s} Σ s \cdot p$$
where s is the signal strength and p is the position of each sensor.

22. The system of claim 21 wherein the spacing between adjacent proximity sensors are substantially the same for all proximity sensors.
